(19) United States
(12) Patent Application Publication
(10) Pub. No.: US 2011/0002465 A1
(43) Pub. Date: Jan. 6, 2011

(54) INTEGRATED HANDOVER AUTHENTICATING METHOD FOR NEXT GENERATION NETWORK (NGN) WITH WIRELESS ACCESS TECHNOLOGIES AND MOBILE IP BASED MOBILITY CONTROL

(75) Inventors: Jae-Young Ahn, Daejeon-city (KR); Souhwan Jung, Seoul (KR); Jaeduck Choi, Seoul (KR); Dae-Joon Hwang, Seoul (KR)

Correspondence Address: NELSON MULLINS RILEY & SCARBOROUGH LLP;FLOOR 30, SUITE 3000, ONE POST OFFICE SQUARE, BOSTON, MA, 02109, US

(73) Assignee: ELECTRONICS AND TELECOMMUNICATIONS RESEARCH INSTITUTE, Daejeon-city (KR)

(21) Appl. No.: 12/809,301

(22) PCT Filed: Dec. 9, 2008
(86) PCT No.: PCT/KR2008/007260

§ 371 Date: Sep. 20, 2010

(30) Foreign Application Priority Data
Dec. 18, 2007 (KR) 10-2007-0133738

(51) Int. Cl. H04W 12/04

(52) U.S. Cl. 380/272

(57) ABSTRACT

Integrated handover authentication technology for a next generation network (NGN) environment to which wire-less access technology and mobile IP based mobility control technology are applied is provided. In a method of operating a mobile terminal MN in order to perform the integrated handover authentication in the NGN environment including an access router PAR, a target router NAR, and an authentication(AAA) server. First, a handover authentication key HK_{NAR} which is shared by the mobile terminal and the target router and protects a fast binding update (FBU) message between the mobile terminal and the target router is generated. Then, an authentication request message AAuthReq generated using the handover authentication key HK_{NAR} is transmitted. Thereafter, an authentication success message AAuthResp is received in response to the authentication request message AAuthReq. Accordingly, hierarchical handover can be performed according to the localization of the mobility of the mobile terminal, thereby minimizing the overhead of the authentication (AAA) server.

### TECHNICAL FIELD

This application claims the benefit of Korean Patent Application No. 10-2007-0133738, filed on Dec. 18, 2007, in the Korean Intellectual Property Office, the disclosure of which is incorporated herein in its entirety by reference.

The present invention relates to integrated handover authentication technology for n ext generation network (NGN) environments to which wireless access technology and mobile IP based mobility control technology have been applied . More particularly, the present invention relates to technology that makes up for the disadvantage in that although basically defining IP-based network mobility control technology together with wireless access technologies such as IEEE 802.11 , 802.16e, and third generation (3G) mobile communications and employing an integrated authentication model that integrates and accepts authentication procedures for wireless access technologies such as IEEE 802.11 , 802.16e, and third generation (3G) mobile communications, a NGN network attachment technology standard being currently developed by ITU-T [International Telecommunication Union] does not appropriately define coherent technology that has considered even an integrated handover authenticating method.

The present invention is derived from a research project supported by the Information Technology (IT) Research & Development (R&D) program of the Ministry of Information and Communication (MIC) and the Institute for Information Technology Advancement (IITA) [2007-P10-30, Development of B roadband convergence network (BcN) Converged Numbering Plan Standard].

### BACKGROUND ART

When a variety of different types of access techniques are applied, low layer controlling methods of extensible authentication protocol (EAP) based authentication are individually developed according to the types of access techniques, and a NGN trying to establish an IP based convergence network employs an integrated authenticating method for integrating the low layer controlling methods of extensible authentication protocol (EAP).

An EAP-based integrated authenticating method is defined in a NGN A NGN has a structure comprised of four elements, that is, an authentication server (AS), an authenticator, an enforcement point (EP), and a peer. These components are matched with functional nodes (e.g., AS-AAA, Authenticator-AR, EP-AP, Peer-MN) of each of 802.11-FMIPv6, 802.16e-FMIPv6, and 3G-FMIPv6 networks, in a one-to-one correspondence.

In this case, when considering a case where a terminal moves, handover authentication needs to be added to EAP authentication with respect to a link layer, and simultaneously a handover authentication procedure needs to be performed because handover occurs even in a network layer such as a mobile IP. In particular, in order to achieve fast handover, unnecessary redundant procedures of authentication control signaling need to be minimized through integrated authentication between an EAP layer and a network layer, and a handover procedure itself needs to be consistently protected.

Examples of the handover authentication technique include a binding update protection technique (e.g., IETF RFC4086) proposed by a mobile IP layer, authentication, authorization, and accounting (AAA) based handover authentication (e.g., IETF draft-ietf-mipshop-3gfh-03), a handover authentication technique using a secure context transmitting method using SEND function (IETF draft-ietf-mipshop-handover-key-00), etc. These examples only consider handover authentication with respect to network layers.

Several handover authenticating methods for a mobile access layer have been proposed. In particular, various methods such as IEEE 802.1X EAP-based authentication, a proactive key distributing method, and a mobility prediction technique have been proposed for WLAN. However, these methods also have been proposed only considering wireless access layers. When these methods are used together with handover authentication for other layers, many duplicate messages may be generated. In this way, existing handover authenticating methods have a burdensome protocol design from the viewpoint of integration.

### DISCLOSURE OF INVENTION

### Technical Problem

Consequently, although a large number of handover authenticating methods have been proposed for each of Layer 2 and Layer 3, a method of controlling integrated authentication in consideration of mobility and managing keys 1 has not yet been proposed, by which authenticating procedures for layers that occur in an access stage of a network having an integrated structure such as the NGN are effectively integrated and integrated handover authentication is appropriately performed when a terminal moves.

### Technical Solution

The present invention provides an efficient integrated authentication controlling structure for omitting unnecessary redundant messages by integrally controlling handover authentication procedures with respect to the mobility of a terminal in different layers, when various different types of accesses and mobile IP based network mobility procedures are performed in n ext generation network (NGN) access environments, and an hierarchical method for allowing each of the layers to perform local handover authentication of a predetermined level in order to prevent extension of un unnecessary control area caused by integrated authentication when local mobility occurs.

### Advantageous Effects

As described above, the present invention provides a method of integrally performing handover authentications due to the movement of a terminal between layers in a communications network to which a variety of wireless access technology including a WLAN and the mobility of a mobile IP based network layer including FMIPv6 technology are both applied. According to this method, the number of incidental messages generated during handover authentication is minimized. In particular, hierarchical handover can be performed according to the localization of the mobility of a mobile terminal, thereby minimizing the overhead of an authentication server.

The present invention also provides an integrated handover authentication method suitable for an access integrated authentication control structure of a next generation network (NGN) being currently standardized in ITU-T and a b roadband convergence network (BcN) being under development within Korea.

According to the present invention, when a mobile terminal moves between access points, that is, undergoes handover, in a communications network where IEEE802 wireless access technology and mobile IP are combined together, an authentication procedure is simplified, and thus faster handover is performed.

Moreover, a complicated AAA-centered authentication procedure is not required during local movement that generates only the mobility of a link layer, and thus the effect of the present invention is more prominent. Various link techniques are integrated using a key managing method, and thus handover between different access networks and authentication thereof can be easily accomplished.

### DESCRIPTION OF DRAWINGS

The above and other features and advantages of the present invention will become more apparent by describing in detail exemplary embodiments thereof with reference to the attached drawings in which:

FIG. 1 illustrates the definitions of keys for use in an integrated handover authenticating method according to an exemplary embodiment of the present invention and a configuration of the keys;

FIG. 2 illustrates a message flow and a key managing method in a method of performing integrated handover authentication in a predictive mode, which is a handover processing method based on mobility prediction according to an exemplary embodiment of the present invention;

FIG. 3 illustrates a message flow and a key managing method in a method of performing integrated handover authentication in a reactive mode, which is a later response processing method according to an exemplary embodiment of the present invention;

FIG. 4 illustrates an application of a 802.11-FMIPv6 network integrated handover authentication method according to an exemplary embodiment of the present invention to the structure of a next generation network (NGN) integrated authentication model; and

FIG. 5 illustrates a structure in a hierarchical structure key illustrated in FIG. 4, according to an exemplary embodiment of the present invention .

### BEST MODE

The present invention provides an efficient integrated authentication controlling structure for omitting unnecessary redundant messages by integrally controlling handover authentication procedures with respect to the mobility of a terminal in different layers, when various different types of accesses and mobile IP based network mobility procedures are performed in n ext generation network (NGN) access environments, and an hierarchical method for allowing each of the layers to perform local handover authentication of a predetermined level in order to prevent extension of un unnecessary control area caused by integrated authentication when local mobility occurs.

The present invention also provides a method in which a mobile terminal directly generates and manages handover keys, by which a stable channel is formed between an access router (AR) and an authentication, authorization, and accounting (AAA) authentication server, an environment in which the AAA authentication server and the mobile terminal share an e xtended master session key (EMSK) defined in the extensible authentication protocol (EAP) standard document (e.g., RFC 3748) of IETF is defined, and an encryption master key (EMK) for encrypting an authentication master key (AMK) for authentication between a server and the mobile terminal and a handover authentication key, that is, a handover key (HK), that is to be shared by the mobile terminal and a new AR can be generated using the EMSK.

The present invention also provides a method of applying different efficient integrated authentication procedures and different key management models to a predictive handover authentication model and a reactive handover authentication.

The present invention also provides adaptive applications of handover authentication methods to a NGN integrated authentication model being currently developed in ITU-T. More particularly, the present invention also provides a structure for performing a mobile node-led handover authentication based on a AAA authentication server when the mobile node performs network layer handover and for hierarchically managing handover authentication keys of access points (APs) or base stations (BSs) in an AR upon link layer handover, wherein the structure is developed by adding a hierarchical management technique to the above-described handover authentication technology.

According to an aspect of the present invention, there is provided a method of operating a mobile terminal (MN) in order to perform integrated handover authentication in a next generation network (NGN) environment including a previous access router (PAR), a target router (NAR, i.e., a new access router), and an authentication, authorization, and accounting (AAA) server, the method comprising: (a) generating a handover authentication key HK_{NAR} which is shared by the mobile terminal and the target router and protects a fast binding update (FBU) message between the mobile terminal and the target router; (b) transmitting an authentication request message AAuthReq generated using the handover authentication key HK_{NAR}; and (c) receiving an authentication success message AAuthResp in response to the authentication request message AAuthReq.

In (a), the handover authentication key HK_{NAR} is generated by setting a current time of the mobile terminal as a key value and solving a hash operation by use of an identification code ID_{MN} that can identify the mobile terminal and an identification code ID _{NAR} that can identify the target router.

In (b), the authentication request message AAuthReq is transmitted, wherein the authentication request message AAuthReq includes a value E_{EMK}(HK_{NAR}) generated by encrypting the handover authentication key HK_{NAR}, a value MAC_{MN}_{_{—}}_{AAA} generated by encrypting information used by the authentication server to authenticate the mobile terminal, and a value MAC_{MN}_{_{—}}_{PAR} generated by encrypting the information used by the access router to authenticate the mobile terminal.

In (c), the authentication success message AAuthResp generated using the handover authentication key HK_{NAR} included in the authentication request message AAuthReq is received.

The method further comprises: (d) transmitting the FBU message when the mobile terminal is handed over from the access router to the target router, wherein the FBU message includes an address used by the mobile terminal within the access router and an address to be used by the mobile terminal within the target router; and (e) transmitting a fast neighbor advertisement (FNA) message generated using the identification code ID_{MN} that can identify the mobile terminal and the handover authentication key HK_{NAR} when the handover has been completed.

According to another aspect of the present invention, there is provided a method of operating a mobile terminal (MN) in order to perform integrated handover authentication in a next generation network (NGN) environment including an previous access router PAR, a target router NAR, and an authentication (AAA) server, the method comprising: (a) transmitting an authentication request message AAuthReq generated using a handover authentication key HK_{NAR} shared by the mobile terminal and the target router upon handover, when a handover of the mobile terminal from the access router to the target router has been completed; and (b) receiving an authentication success message AAuthResp generated using the handover authentication key HK_{NAR}, when the mobile terminal can be authenticated.

In (a), the authentication request message AAuthReq is transmitted, wherein the authentication request message AAuthReq includes a value E_{EMK}(HK_{NAR}) generated by encrypting the handover authentication key HK_{NAR}, a value MAC_{MN}_{_{—}}_{AAA} generated by encrypting information used by the authentication server to authenticate the mobile terminal, and a value MAC_{MN}_{_{—}}_{PAR} generated by encrypting the information used by the access router to authenticate the mobile terminal.

In (b), when the authentication server determines using the authentication request message AAuthReq that the mobile terminal can be authenticated, the handover authentication key HK_{NAR} comprised in the authentication request message AAuthReq is decoded, and the authentication success message AAuthResp generated using handover authentication key HK_{NAR} is received.

According to another aspect of the present invention, there is provided a method of operating an authentication(AAA) server in order to perform integrated handover authentication in a next generation network (NGN) environment including an access router PAR, a target router NAR, and the authentication (AAA) server , the method comprising: (a) allocating session mask keys (SMKs) to access points (APs) included in each of the access router and the target router by using a handover authentication key (HK_{PAR} or HK_{NAR}) shared by a mobile terminal MN, the access router, and the target router; and (b) performing link layer authentication with the mobile terminal by using the handover authentication key (HK_{PAR}) and session mask keys for the access points to which the mobile terminal is handed over, when the mobile terminal is handed over to different access points included in the access router.

(b) comprises: (b1) sequentially receiving an authentication request message

AAuthReq generated by using the handover authentication key HK_{NAR} from the access router and the target router when the mobile terminal is handed over from an access point within the access router to an access point within the target router, and sequentially transmitting an authentication success message AAuthResp generated using the handover authentication key HK_{NAR} to the target router, the access router, and the mobile terminal when the authentication server determines that the mobile terminal can be authenticated, so as to perform network layer authentication; and (b2) performing link layer authentication with the mobile terminal by using the handover authentication key HK_{NAR} and a session mask key for the access point to which the mobile terminal is handed over.

(b) comprises: (b1) receiving an authentication request message AAuthReq generated by using a handover authentication key HK_{NAR} shared by the mobile terminal and the target router upon handover from the target router which has received the authentication request message AAuthReq from the mobile terminal when the mobile terminal has been completely handed over from the access router within the access router to the access point within the target router and which has received a FBU message comprising an address used by the mobile terminal within the access router from the access router, and sequentially transmitting an authentication success message AAuthResp generated using the handover authentication key HK_{NAR} to the target router and the mobile terminal when the authentication server determines that the mobile terminal can be authenticated, so as to perform network layer authentication; and (b2) performing link layer authentication with the mobile terminal by using the handover authentication key HK_{NAR} and a session mask key for the access point to which the mobile terminal is handed over.

According to another aspect of the present invention, there is provided a n integrated handover authentication method of a mobile terminal MN in a next generation network (NGN) environment comprising an access router PAR, a target router NAR, and an authentication (AAA) server, the integrated handover authentication method comprising: (a) generating a handover authentication key HK_{NAR} which is shared by the mobile terminal and the target router and protects a fast binding update (FBU) message between the mobile terminal and the target router at the mobile terminal; (b) sequentially transmitting an authentication request message AAuthReq generated using the handover authentication key HK_{NAR} to the access router, the target router, and the authentication server from the mobile terminal; and (c) sequentially transmitting an authentication success message AAuthResp generated using the handover authentication key HK_{NAR} to the target router, the access router, and the mobile terminal when the authentication server determines that the mobile terminal can be authenticated from the authentication server.

In (a), the handover authentication key HK_{NAR} is generated by setting a current time of the mobile terminal as a key value and solving a hash operation by use of an identification code ID_{MN} that can identify the mobile terminal and an identification code ID _{NAR} that can identify the target router.

In (b), the authentication request message AAuthReq comprises a value E_{EMK}(HK_{NAR}) generated by encrypting the handover authentication key HK_{NAR}, a value MAC_{MN}_{_{—}}_{AAA} generated by encrypting information used by the authentication server to authenticate the mobile terminal, and a value MAC_{MN}_{_{—}}_{PAR} generated by encrypting the information used by the access router to authenticate the mobile terminal.

In (c), when the authentication server determines using the received authentication request message AAuthReq that the mobile terminal can be authenticated, the authentication server decodes the handover authentication key HK_{NAR} included in the authentication request message AAuthReq and transmits the authentication success message AAuthResp generated using handover authentication key HK_{NAR} to the target router, the access router, and the mobile terminal.

The integrated handover authentication method further comprises: (d) sequentially transmitting a FBU message comprising an address used by the mobile terminal within the access router and an address to be used by the mobile terminal within the target router to the access router and the target router, when the mobile terminal is handed over from the access router to the target router; and (e) transmitting an FNA message generated by using an identification code ID_{MN} that can identify the mobile terminal and the handover authentication key HK_{NAR} to the target router, when the handover has been completed.

### Mode for Invention

The present invention will now be described more fully with reference to the accompanying drawings, in which exemplary embodiments of the invention are shown.

A system structure to which the present invention is applied is based on the following assumptions.

It is assumed that a stable channel is formed between an access router (AR) and an authentication, authorization, and accounting (AAA) authentication server by using a transport layer security (TLS) or an IP security (IPsec) protocol in a mobile IP environment such as FMIPv6.

It is also assumed that a mobile node (MN) stably stores in a terminal an extended master session key (EMSK) shared with an AAA authentication serverthrough initial authentication such as EAP-TLS during booting.

It is also assumed that an authentication master key (AMK) and an encryption master key (EMK) used in the present invention are derived from the EMSK as described below.

It is also assumed that the AMK is used by the AAA authentication server to authenticate mobile terminals and that the EMK is used by mobile terminals to encrypt a handover authentication key, namely, a handover key (HK) to be shared with a new AR (NAR).

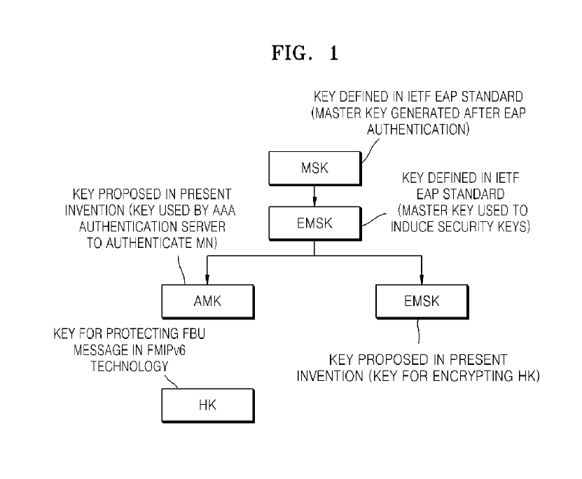

FIG. 1 illustrates the definitions of keys for use in an integrated handover authenticating method according to an exemplary embodiment of the present invention and a configuration of the keys.

An EMSK is defined in RFC 3748, which is an extensible authentication protocol (EAP) standard document of the Internet Engineering Task Force (IETF), and used as a master key for generating other security keys in network communications.

The EMSK is derived from a master session key (MSK) generated after authentication between an EAP peer and an EAP server has been successfully performed.

When the MSK is directly used in a process of inducing other security keys, such as data encryption and data integrity, if the MSK is figured out or discovered from the induced security keys, the stability of the entire security communications is disturbed. To address this problem, the EMSK is used.

Accordingly, the stability of security communications can be improved by generating an EMSK and inducing other security keys from the EMSK instead of inducing the other security keys from a MSK. In general, a key inducing process in security communications does not include a process of inducing other security keys directly from a MSK, which is the uppermost root key.

An AMK is a key proposed by the present invention. In handover authentication technology according to the present invention, in order to divide handover authentication keys between an MN and an AR, the MN generates an HK and transmits the same to a NAR via the AAA authentication server.

The AMK is an authentication key which is used when an AAA authentication server authenticates the MN. The AAA authentication server recognizes using a MACMN_AAA value that it shares the AMK with a MN that requests for handover authentication in order to proceed with the MN handover authentication.

As shown in the following equation, the MN generates a message authentication code (MAC) by using the AMK that is shared with the AAA authentication server, and the AAA authentication server authenticates the value of the MAC in order to determine whether a handover authentication process is to be properly performed.

Equation

MAC_{MN}_{_{—}}_{AAA}=H(AMK, ID_{MN}||ID_{NAR}||ID_{AAA}||E_{EMK}(HK _{NAR}))

To be more specific about the Equation, an EMK is a key proposed by the present invention. The EMK is used to encrypt an HK in order to prevent the HK of the MN from being displayed as a plaintext to a third person while the HK is being transmitted to an AR.

As in E_{EMK}(HK), the HK is encrypted into the EMK by using an encryption algorithm. The encryption algorithm used in the present invention is not limited to a specific algorithm. In other words, several encryption algorithms such as AES, DES, etc. may be used.

The HK is a key proposed in the present invention. Before the MN is handed over to a NAR, the MN previously registers in a previous access router (PAR) an IPv6 address that is to be used in the NAR.

This process corresponds to a fast binding update (FBU) in FMIPv6 technology. The

FBU is defined in the FMIPv6 technology. The HK is used to stably perform FBU as follows:

H(HK, FBU)

wherein H( )indicates a value generated by using the HK and the FBU in a hash function.

A master key generating method is expressed as in Equation 1 below:

AMK=H(EMSK₀_{_{—}}₃₁, ‘Authentication Key’)

EMK=H(EMSK₃₂_{_{—}}₆₃, ‘Encryption Key’) (Equation 1)

where EMSK_{X}_{_{—}}_{Y} indicates bits from an X-th bit to a Y-th bit of an EMSK.

H( )indicates a one-way hash function (e.g., SHA, MD5, etc.).

E_{EMK}( )used in other equations indicates encryption of the contents encompassed in ( ) by using an EMK. Various encryption algorithms such as AES, DES, etc. may be used.

According to Equation, AMK=H(EMSK0_{—}31, ‘Authentication Key’), an AMK is generated by inputting 32 bit values, from a zero-th bit to a thirty-first bit, of the EMSK and a text ‘Authentication Key’ to the hash function. The length of the AMK depends on the type of used hash function.

According to Equation, EMK=H(EMSK32_{—}63, ‘Encryption Key’), an EMK is generated by inputting 32 bit values, from a thirty second bit to a sixty-third bit, of the EMSK and a text ‘Encryption Key’ to the hash function. The length of the EMK depends on the type of used encryption algorithm.

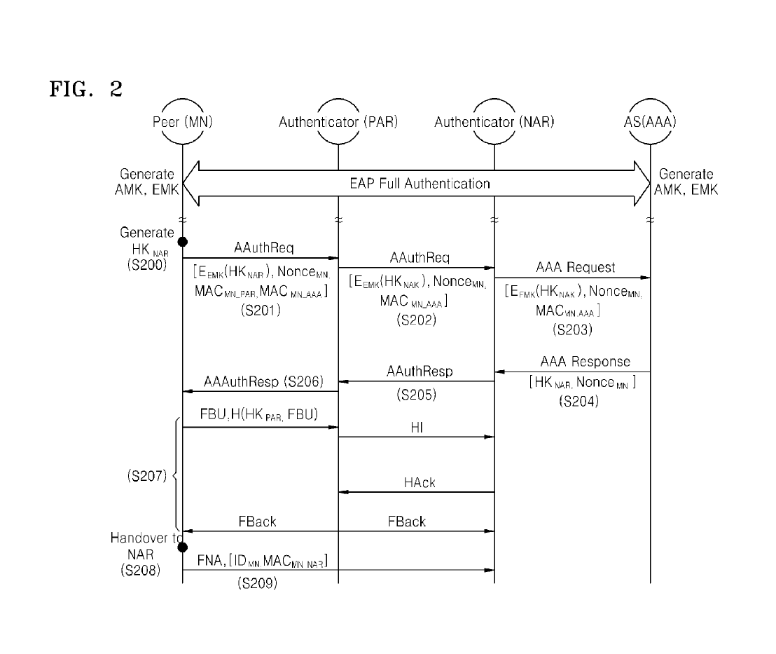

Predictive handover authentication technology will now be described with reference to FIG. 2.

FIG. 2 illustrates a message flow and a key managing method in a method of performing integrated handover authentication in a predictive mode, which is a handover processing method based on mobility prediction according to an exemplary embodiment of the present invention.

A MN performs handover authentication using messages AAuthReq and AAuthResp before handover occurs in a link layer.

Information included in the messages AAuthreq and AAuthresp varies according to handover modes (e.g., a predictive handover mode and a reactive handover mode) of FMIPv6 technology and sections (e.g., a MN-PAR section, a PAR-NAR section, and a MN-NAR section). The two messages are proposed by the present invention.

MAC_{X}_{_{—}}_{Y} indicates that X generates an MAC value and Y authenticates the MAC value.

As illustrated in FIG. 2, in the predictive handover mode, the information included in the messages AAuthreq and AAuthresp is as follows:

In the MN-PAR section, the message AAuthreq includes E_{EMK}(HK_{NAR}), Nonce_{MN}, MAC_{MN}_{_{—}}_{PAR}, and MAC_{MN}_{_{—}}_{AAA}.

In the PAR-NAR section, the message AAuthreq includes E_{EMK}(HK_{NAR}), Nonce_{MN}, and MAC_{MN}_{_{—}}_{AAA}.

MAC_{MN}_{_{—}}_{PAR} is removed in the PAR-NAR section, because a PAR authenticates a value MAC_{MN}_{_{—}}_{PAR} and the MN has been identified as an authenticated node.

In the NAR-PAR-MN section, the message AAuthresp includes a phrase ‘Success’ or ‘Fail’, which indicates an authentication success or failure. The authentication success means that the MN has been authenticated by an AAA authentication server and an HK has been properly transmitted to the NAR.

When the MN is handed over to the NAR, the NAR includes MAC_{MN}_{_{—}}_{NAR} in a message FNA (fast neighbor advertisement) in order to re-authenticate the MN. The NAR approves handover when the value MAC is right.

The key managing method will now be described with reference to FIG. 2. First, in operation S200, the MN generates MAC values and HK_{NAR},which is to be shared with the NAR, as described below.

MAC_{MN}_{_{—}}_{PAR} is a value used by the PAR to authenticate the MN, and MAC_{MN}_{_{—}}_{AAA} is a value used by the AAA authentication server to authenticate the MN.

An MAC is a value generated by solving a hash function H( )(e.g., SHA1, SHA256, MD5, etc.) by use of a key shared between two nodes.

A hash function, which is a cryptological value used to achieve the integrity of messages and authentication between two nodes, generally corresponds to a case where a content is included as an input value in H( ) for example, H(content). When a content and a key value are included as input values in the hash function H( ) this case, for example, H(key, content), is referred to as an HMAC function. However, these two cases denote the same hash function H( )and are different only in terms of the name.

In other words, although the two types of hash functions are the same in terms of a hash function, they are distinguished from each other according to inclusion or non-inclusion of a key value. The MAC value is generated using the key value included in the hash function.

A NAR is a term defined in FMIPv6 technology of IETF, and denotes an AR to which the MN is to be handed over next. The NAR is the third layer (a network layer) and accordingly is a mobile router. The NAR informs the MN of network information (e.g., prefix information of IPv6).

A previous access router (PAR) is a term defined in FMIPv6 technology of IETF, and denotes an AR in which the MN is currently included. In other words, the PAR denotes an AR existing prior to the NAR to which the MN is to be handed over.

A handover authentication key generating method is expressed as in Equation 2 as follows:

HK_{NAR}=H(Time_stamp||RN_{MN}, ID_{MN}||ID_{NAR})

MAC_{MN}_{_{—}}_{PAR}=H(HK_{PAR}, ID_{MN}||ID_{NAR}||ID_{AAA}||E_{EMK}(HK _{NAR})|| MAC_{MN}_{_{—}}_{AAA})

MAC_{MN}_{_{—}}_{AAA}=H(AMK, ID_{MN}||ID_{NAR}||ID_{AAA}||E_{EMK}(HK _{NAR})) (Equation 2)

wherein MACₓ_{_{—}}_{y} indicates that the MAC value is generated in a node x and authenticated in a node y.

In Equation 2, ID_{MN} denotes an identifier (ID) of the MN (e.g., an IP address of the MN or an ID allocated by other network service providers). Accordingly, ID_{X} denotes an ID of a node X.

Nonce_{MN} denotes a random value generated by the MN. Accordingly, Nonce denotes a Nonce value generated by the node X.

HK_{NAR} is a handover authentication key that is to protect a FBU message shared between the MN and the NAR when the MN is handed over to a next NAR (NNAR).

HK_{PAR} is a key shared by the MN and the PAR, and is used to protect a FBU message between the MN and the PAR when the MN is handed over to the NAR.

In HK_{NAR}=H(Time_stamp||RN_{MN}, ID_{MN}||ID_{NAR}), Time_stamp denotes a time of the current MN, ‘||’ denotes concatenation (that is, connection of two consecutive values). For example, when ID_{MN} is ‘AA’ and ID_{NAR} is ‘BB’, the value of ID_{MN}||ID_{NAR} is AABB.

In MAC_{MN}_{_{—}}_{PAR}=H(HK_{PAR}, ID_{MN}||ID_{NAR}||ID_{AAA}||E_{EMK}(HK _{NAR})||MAC_{MN}_{_{—}}_{AAA}, MAC_{MN}_{_{—}}_{PAR} is generated by the MN in order for the PAR to authenticate the MN at the request of the MN for handover authentication. HK_{PAR} is a key shared by the MN and the PAR through previous handover authentication. By using the key HK_{PAR}, the PAR can authenticate the MN.

E_{EMK}(HK_{NAR}) and MAC_{MN}_{_{—}}_{AAA} are included as input values in the equation for generation of the value of MAC_{MN}_{_{—}}_{PAR} in order to prevent the two values from being modulated while the message AAuthreq including the two values is being transmitted to the PAR.

When the PAR performs handover authentication on a not-yet authenticated MN, unnecessary network traffic may be generated by many handover authentication request messages from ill-intentioned attackers, and the handover of a normal MN may be interrupted.

In MAC_{MN}_{_{—}}_{AAA}=H(AMK, ID_{MN}||ID_{NAR}||ID_{AAA}||E_{EMK}(HK _{NAR})), MAC_{MN}_{_{—}}_{AAA} is a value generated by the MN in order for the AAA authentication server to authenticate the MN at the request of the MN for handover authentication, and AMK is a key previously shared by the MN and the AAA authentication server. In other words, AMK is a key derived from EMSK.

Similarly, parameters included in a function H( ) are used to prevent modulations by an ill-intentioned node while transmitting.

After these values are generated in this way in operation S200, the MN transmits the message AAuthReq to the PAR so as to drive a handover authentication process, in operation S201.

When the PAR authenticates MAC, p_{AR} included in the message AAuthReq and the authentication is successfully performed, the message AAuthReq is transmitted to the NAR, in operation S202. Thereafter, in operation S203, the NAR generates an authentication cash table by using the values of ID_{MN} and Nonce_{MN} of a mobile terminal and then transforms the message AAuthReq into an AAA AVP type, thereby transmitting an AAA request message to the AAA authentication server.

Since the NAR has received the handover authentication request values of the MN from the PAR but the received handover authentication request values are not yet authenticated by the AAA authentication server, the received values are temporarily stored. When the NAR receives finally authenticated values from the AAA authentication server via the AAA response message, the NAR completes the authentication cash table by using the finally authenticated values (e.g., HK_{NAR}, Nonce_{MN}, and ID_{MN}). If the NAR receives a message AAA response indicating a failure of MN handover authentication, the authentication cash table is deleted.

Attribute value parameters (AVP) are equivalent to a header field in which each parameter required by AAA communications is reflected. The AVP is a format defined in order to transmit the parameters required by AAA communications.

In response to the AAA request message, the AAA authentication server determines whether to allow or refuse a handover requested by the MN in the present invention (i.e., FMIPv6 handover authentication). Accordingly, when the MN is handed over to the NAR, a handover authentication message is supposed to pass through the AAA authentication server.

This technology is referred to as handover authentication technology based on an AAA authentication server. The AAA request message denotes a protocol message for communications between the NAR and the AAA authentication server. The AAA request message transmits the handover authentication request messages of the MN received by the NAR to the AAA authentication server. In other words, the AAA request message requests for authentication of the MN by flowing between the NAR and AAA.

The AAA authentication server may use a diameter or radius protocol. However, the present invention is not limited to the use of other kinds of protocols.

In response to the AAA request message, the AAA authentication server identifies ID _{MN} and authenticates MAC_{MN}_{_{—}}_{AAA} by using the AMK of ID_{MN}. When this authentication is successful, the AAA authentication server decodes HK_{NAR} and transmits HK_{NAR} and Nonce_{MN} via a stable channel between the NAR and the AAA authentication server in operation S204. The NAR additionally registers HK_{NAR} in the authentication cash table and then transmits an authentication success message to the MN, in operations S205 and S206.

In FIG. 2, as described above in operation S203, the NAR transmits E_{EMK}(HK_{NAR} and Nonce_{MN} to the AAA authentication server.

The AAA authentication server obtains the value HK_{NAR} by decoding E_{EMK}(HK_{NAR}) using the EMK.

The AAA authentication server authenticates the value MAC_{MN}_{_{—}}_{AAA} in order to confirm that the handover authentication request message including Nonce_{MN} has not been changed. The AAA authentication server transmits HK_{NAR} and Nonce_{MN} to the NAR as described above in operation S204.

In other words, because the two values HK_{NAR} and Nonce_{MN} have been authenticated and checked by the AAA authentication server, the NAR determines the two values HK_{NAR} and Nonce_{MN} to be safe and uses them.

The value HK_{NAR} is used to protect the FBU message when the MN is handed over from the NAR to the NNAR.

As described above, FBU is a term defined in IETF FMIPv6 technology.

When the MN is handed over between the PAR and the NAR, the MN needs to inform the PAR of an address that is to be used in the NAR. Accordingly, packets under communications between the MN and the PAR can be re-directed to the NAR.

The process of the MN informing the PAR of an IP address to be used in NAR is referred to as a FBU process. In other words, in the FBU process, the MN informs the PAR that the IPv6 address of the MN has been changed. The FBU process is performed before the MN is actually handed over to the NAR.

FBU information may include an IPv6 address of the MN used by the PAR, an IPv6 address of the MN that is to be used by the NAR, and the like, in operation S207.

When the MN is handed over, an HMAC value (upon a hash algorithm SHA-1) with respect to FBU is generated using HK_{PAR} shared by the MN and the PAR in order to protect the message FBU, in operation S208. When the MN is moved to the NAR S208 and then transmits the message FNA, a value MAC_{MN}_{_{—}}_{NAR} is generated, and thus proper exchange of the value HK_{NAR} has been finally verified and a handover of the MN is accepted, in operation S209.

As described above, FNA is a term defined in IETF FMIPv6 technology. The message FNA is used by the MN to inform the NAR that the MN has been handed over to the NAR.

A source address (i.e., the IPv6 address of the MN to be used by the NAR), a destination address (i.e., the IPv6 address of the NAR), and other data, which are FNA information, are optionally defined in an FNA packet.

A handover key authentication code generating method is expressed as in Equation 3 as follows:

MAC_{MN}_{_{—}}_{NAR}=H(HK_{NAR}, Nonce_{MN}||ID_{MN} ||ID_{NAR}) (Equation 3)

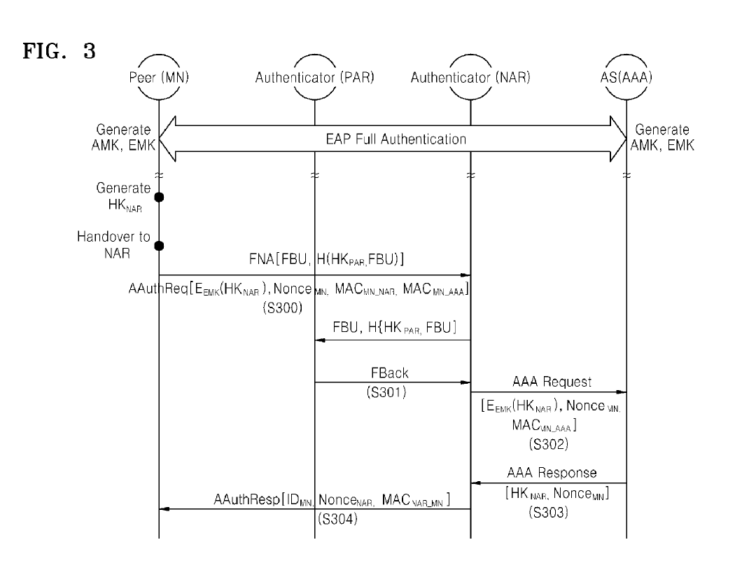

Reactive handover authentication technology will now be described with reference to FIG. 3.

FIG. 3 illustrates a message flow and a key managing method in a method of performing integrated handover authentication in a reactive mode, which is a later response processing method according to an exemplary embodiment of the present invention.

In the reactive handover authentication mode, the MN transmits a handover authentication message after handovers of a link layer and a network layer to the NAR is performed. First, in operation S300, the MN generates a value HMAC with respect to the FBU message by using a value HK_{PAR} that has been already shared with the PAR, calculates the following values that are to be included in a message AAuthReq, and then transmits a message FNA and the message AAuthReq to the NAR.

Two messages AAuthReq and AAuthResp in the reactive handover authentication mode of FIG. 3 include the following information.

In a MN-NAR section, the message AAuthreq includes E_{EMK}(HK_{NAR}), Nonce_{MN}, MAC_{MN}_{_{—}}_{NAR}, and MAC_{MN}_{_{—}}_{AAA}.

Since the MN has been already handed over to the NAR, the message AAuthreq includes a value MAC_{MN}_{_{—}}_{NAR} instead of a value MAC_{MN}_{_{—}}_{PAR}.

In a NAR-MN section, when authentication is successful, the message AAuthresp includes ID_{MN}, Nonce_{NAR}, MAC_{NAR}_{_{—}}_{MN}, and a phrase ‘Success’. On the other hand, when authentication is failed, the message AAuthresp includes a phrase ‘Fail’.

The authentication success means that the MN has been authenticated by the AAA authentication server and an HK has been properly transmitted to the NAR.

In order to get an authentication from the MN, the NAR also generates a value MAC _{NAR}_{_{—}}_{MN} by using the HK and transmits the MAC_{NAR}_{_{—}}_{MN} to the MN, in operation S304.

An MAC generating method is expressed as in Equation 4 as follows:

MAC_{MN}_{_{—}}_{AAA}=H(AMK, ID_{MN}||ID_{NAR}||ID_{AAA}||Nonce_{MN}||E _{EMK}(HK_{NAR}))||MAC_{MN}_{_{—}}_{NAR})

MAC_{MN}_{_{—}}_{NAR}=H(HK_{NAR}, Nonce_{MN}||ID_{MN} ||ID_{NAR}) (Equation 4)

In operation S301, the NAR, which is a newly connected access router, allows the PAR to perform a FBU procedure, before generating an authentication cash table associated with a value ID_{MN}. When the PAR succeeds in performing the FBU procedure based on FBU message, the NAR generates the authentication cash table associated with the value ID_{MN} and transmits an AAA request message to the AAA authentication server, in operation S302.

In response to the AAA request message, the AAA authentication server identifies the value ID_{MN} and authenticates the value MAC_{MN}_{_{—}}_{AAA} by using the AMK of the value ID_{MN} stored in the AAA authentication server. When the authentication is successful, the AAA authentication server decodes the value HK_{NAR} and transmits a value Nonce _{MN} and the decoded value HK_{NAR} to the NAR via a stable channel between the NAR and the AAA authentication server, in operation S303.

The NAR additionally registers the value HK_{NAR} in the previously generated authentication cash table and then transmits an authentication success message together with the value generated as shown in Equation 5 to the MN, in operation S304. The value HK_{NAR} is used to protect the message FBU when the MN is handed over from the NAR to the NNAR.

Another MAC generating method is expressed as in Equation 5 as follows:

MAC_{NAR}_{_{—}}_{MN}=H(HK_{NAR}, Nonce_{MN}||Nonce_{NAR}||ID_{MN} ||ID_{NAR}) (Equation 5)

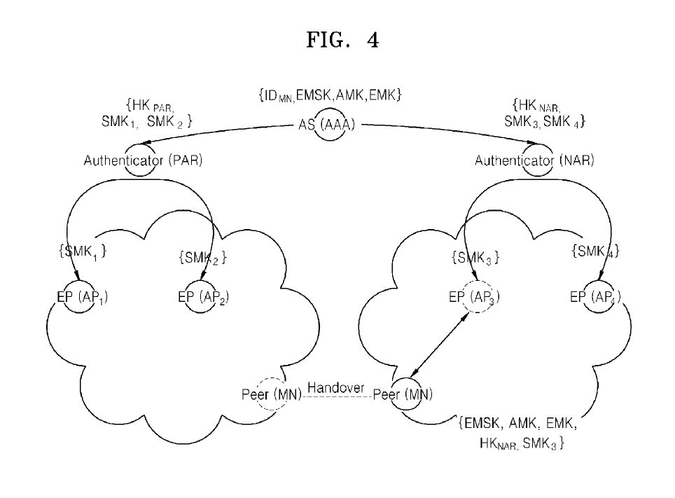

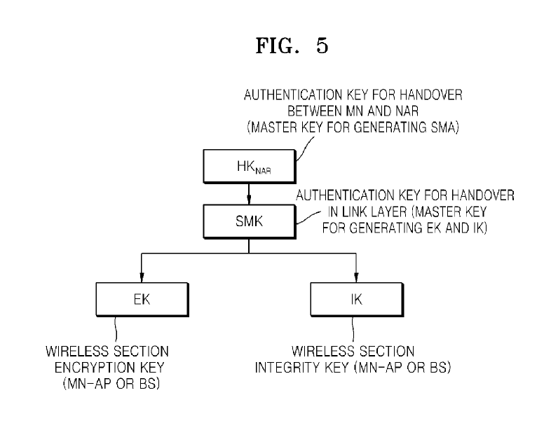

A hierarchical handover authentication procedure based on hierarchical structure key management will now be described with reference to FIGS. 4 and 5.

A handover authentication technique in which the above-described handover authentication procedures are appropriately applied to a NGN integrated authentication model is defined as a hierarchical handover authentication scheme. In the hierarchical handover authentication scheme, when an MN undergoes network layer handover, MN-led handover authentication based on an AAA authentication server is performed, and when the MN undergoes link layer handover, an AR hierarchically manages handover authentication keys of access points (APs) or base stations (BSs) .

FIG. 4 illustrates an application of an 802.11-FMIPv6 network integrated handover authentication method according to an exemplary embodiment of the present invention to a NGN integrated authentication model. This application may also be applied to a 802.16e-FMIPv6 network and a 3G-FMIPv6 network.

Authentication upon handover in an MN will now be described with reference to FIG. 4.

First, the MN performs initial booting at an area AP₁ and performs initial authentication together with an AAA authentication server via a PAR. During the initial booting of the MN, the PAR receives a value HK_{PAR} from the AAA authentication server via a stable channel.

When the MN is handed over to an area AP₂, authentication of the AP₁-AP₂handover replaces link layer handover authentication performed between the MN and the AAA authentication server by using a value SMK₂ (Session Master Key) derived from the value HK_{PAR} of the PAR.

In an AP₂-AP₃ section where handovers between a network layer and a link layer simultaneously occur, two handover authentication techniques proposed above are performed in order to achieve a handover authentication of a network layer, and handover authentication in a link layer is performed using a value SMK₃.

An encryption key (EK) and an integrity key (IK) are used to protect data between the MN and the AP in a wireless section.

A data protection key generating method is expressed as in Equation 6 as follows:

SMK=H(HK_{NAR}, ID_{MN}||ID_{AP}||‘Session Master’)

EK=H(SMK, ID_{MN}||ID_{AP}||Nonce_{MN}||‘Encryption Key’)

IK=H(SMK, ID_{MN}||ID_{AP}||Nonce_{MN}||‘Integrity Key’) (Equation 6)

FIG. 5 illustrates a structure in a hierarchical structure key illustrated in FIG. 4, according to an exemplary embodiment of the present invention .

The base station (BS) described above is a network node of layer 2 (that is, a link layer) in 3GPP or WiMax technology, and serves as an AP in a WLAN.

The SMK is a key used for link layer handover authentication.

Even when the MN is handed over to an AP or a BS, the AP or BS, which is a link layer node, should perform handover authentication on the MN. The present invention proposes a structure for hierarchically generating and managing a key of a link layer on the basis of a value HK_{NAR} generated in layer 3 (that is, a network layer) in order to simplify a handover authentication procedure in a link layer.

Accordingly, when the value HK_{NAR} is allocated by the NAR, the NAR distributes SMKs to APs or BSs included in the NAR. When the MN performs link layer handover, the APs or BSs communicate only MAC values with the MN by using the SMKs, thereby performing handover authentication.

Such an SMK is used to generate an encryption key (EK) and an integrity key (IK) which are used to protect data in a wireless section such as a section between an MN and an AP or a BS. An AR may include several APs or BSs, and distribute specific SMKs to the APs or BSs.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of operating a mobile terminal (MN) in order to perform integrated handover authentication in a next generation network (NGN) environment including a previous access router (PAR), a target router (NAR, i.e., a new access router), and an authentication, authorization, and accounting (AAA) server, the method comprising:
(a) generating a handover authentication key HK_{NAR} which is shared by the mobile terminal and the target router and protects a fast binding update (FBU) message between the mobile terminal and the target router;
(b) transmitting an authentication request message AAuthReq generated using the handover authentication key HK_{NAR}; and
(c) receiving an authentication success message AAuthResp in response to the authentication request message AAuthReq.

2. The method of claim 1, wherein, in (a), the handover authentication key HK _{NAR} is generated by setting a current time of the mobile terminal as a key value and solving a hash operation by use of an identification code ID_{MN} that can identify the mobile terminal and an identification code ID_{NAR} that can identify the target router.

3. The method of claim 1, wherein, in (b), the authentication request message AAuthReq is transmitted, wherein the authentication request message AAuthReq includes a value E_{EMK}(HK_{NAR}) generated by encrypting the handover authentication key HK_{NAR}, a value MAC_{MN}_{_{—}}_{AAA} generated by encrypting information used by the authentication server to authenticate the mobile terminal, and a value MAC_{MN}_{_{—}}_{PAR} generated by encrypting the information used by the access router to authenticate the mobile terminal.

4. The method of claim 1, wherein, in (c), the authentication success message AAuthResp generated using the handover authentication key HK_{NAR} included in the authentication request message AAuthReq is received.

5. The method of claim 1, further comprising:
(d) transmitting the FBU message when the mobile terminal is handed over from the access router to the target router, wherein the FBU message includes an address used by the mobile terminal within the access router and an address to be used by the mobile terminal within the target router; and
(e) transmitting a fast neighbor advertisement (FNA) message generated using the identification code ID_{MN} that can identify the mobile terminal and the handover authentication key HK_{NAR} when the handover has been completed.

6. A method of operating a mobile terminal (MN) in order to perform integrated handover authentication in a next generation network (NGN) environment including an previous access router PAR, a target router NAR, and an authentication (AAA) server, the method comprising:
(a) transmitting an authentication request message AAuthReq generated using a handover authentication key HK_{NAR} shared by the mobile terminal and the target router upon handover, when a handover of the mobile terminal from the access router to the target router has been completed; and
(b) receiving an authentication success message AAuthResp generated using the handover authentication key HK_{NAR}, when the mobile terminal can be authenticated.

7. The method of claim 6, wherein, in (a), the authentication request message AAuthReq is transmitted, wherein the authentication request message AAuthReq includes a value E_{EMK}(HK_{NAR}) generated by encrypting the handover authentication key HK_{NAR}, a value MAC_{MN}_{_{—}}_{AAA} generated by encrypting information used by the authentication server to authenticate the mobile terminal, and a value MAC_{MN}_{_{—}}_{PAR} generated by encrypting the information used by the access router to authenticate the mobile terminal.

8. The method of claim 6, wherein, in (b), when the authentication server determines using the authentication request message AAuthReq that the mobile terminal can be authenticated, the handover authentication key HK_{NAR} comprised in the authentication request message AAuthReq is decoded, and the authentication success message AAuthResp generated using handover authentication key HK_{NAR} is received.

9. A method of operating an authentication(AAA) server in order to perform integrated handover authentication in a next generation network (NGN) environment including an access router PAR, a target router NAR, and the authentication (AAA) server , the method comprising:
(a) allocating session mask keys (SMKs) to access points (APs) included in each of the access router and the target router by using a handover authentication key (HK_{PAR} or HK_{NAR}) shared by a mobile terminal MN, the access router, and the target router; and
(b) performing link layer authentication with the mobile terminal by using the handover authentication key (HK_{PAR}) and session mask keys for the access points to which the mobile terminal is handed over, when the mobile terminal is handed over to different access points included in the access router.

10. The method of claim 9, wherein (b) comprises:
(b1) sequentially receiving an authentication request message AAuthReq generated by using the handover authentication key HK_{NAR} from the access router and the target router when the mobile terminal is handed over from an access point within the access router to an access point within the target router, and sequentially transmitting an authentication success message AAuthResp generated using the handover authentication key HK_{NAR} to the target router, the access router, and the mobile terminal when the authentication server determines that the mobile terminal can be authenticated, so as to perform network layer authentication; and
(b2) performing link layer authentication with the mobile terminal by using the handover authentication key HK_{NAR} and a session mask key for the access point to which the mobile terminal is handed over.

11. The method of claim 9, wherein (b) comprises:
(b1) receiving an authentication request message AAuthReq generated by using a handover authentication key HK_{NAR} shared by the mobile terminal and the target router upon handover from the target router which has received the authentication request message AAuthReq from the mobile terminal when the mobile terminal has been completely handed over from the access router within the access router to the access point within the target router and which has received a FBU message comprising an address used by the mobile terminal within the access router from the access router, and sequentially transmitting an authentication success message AAuthResp generated using the handover authentication key HK_{NAR} to the target router and the mobile terminal when the authentication server determines that the mobile terminal can be authenticated, so as to perform network layer authentication; and
(b2) performing link layer authentication with the mobile terminal by using the handover authentication key HK_{NAR} and a session mask key for the access point to which the mobile terminal is handed over.

12. An integrated handover authentication method of a mobile terminal MN in a next generation network (NGN) environment comprising an access router PAR, a target router NAR, and an authentication (AAA) server, the integrated handover authentication method comprising:
(a) generating a handover authentication key HK_{NAR} which is shared by the mobile terminal and the target router and protects a fast binding update (FBU) message between the mobile terminal and the target router at the mobile terminal;
(b) sequentially transmitting an authentication request message AAuthReq generated using the handover authentication key HK_{NAR} to the access router, the target router, and the authentication server from the mobile terminal; and
(c) sequentially transmitting an authentication success message AAuthResp generated using the handover authentication key HK_{NAR} to the target router, the access router, and the mobile terminal when the authentication server determines that the mobile terminal can be authenticated from the authentication server.

13. The integrated handover authentication method of claim 12, wherein, in (a), the handover authentication key HK_{NAR} is generated by setting a current time of the mobile terminal as a key value and solving a hash operation by use of an identification code ID_{MN} that can identify the mobile terminal and an identification code ID_{NAR} that can identify the target router.

14. The integrated handover authentication method of claim 12, wherein, in (b), the authentication request message AAuthReq comprises a value E_{EMK}(HK_{NAR}) generated by encrypting the handover authentication key HK_{NAR}, a value MAC _{MN}_{_{—}}_{AAA} generated by encrypting information used by the authentication server to authenticate the mobile terminal, and a value MAC_{MN}_{_{—}}_{PAR} generated by encrypting the information used by the access router to authenticate the mobile terminal.

15. The integrated handover authentication method of claim 12, wherein, in (c), when the authentication server determines using the received authentication request message AAuthReq that the mobile terminal can be authenticated, the authentication server decodes the handover authentication key HK_{NAR} included in the authentication request message AAuthReq and transmits the authentication success message AAuthResp generated using handover authentication key HK _{NAR} to the target router, the access router, and the mobile terminal.

16. The integrated handover authentication method of claim 12, further comprising:
(d) sequentially transmitting a FBU message comprising an address used by the mobile terminal within the access router and an address to be used by the mobile terminal within the target router to the access router and the target router, when the mobile terminal is handed over from the access router to the target router; and
(e) transmitting an FNA message generated by using an identification code ID_{MN} that can identify the mobile terminal and the handover authentication key HK_{NAR} to the target router, when the handover has been completed.
